(19) United States
(12) Patent Application Publication
(10) Pub. No.: US 2015/0072080 A1
(43) Pub. Date: Mar. 12, 2015

(54) POLYMERIZATES THAT CAN BE PRODUCED BY THE EMULSION POLYMERIZATION OF FUNCTIONALIZED POLYURETHANE NANOPARTICLES AND RADICALLY CURABLE MONOMERS, A METHOD FOR THE PRODUCTION OF SAID POLYMERIZATES, AND USE OF SAID POLYMERIZATES

(71) Applicant: Dritte Patentportfolio Beteiligungsgesellschaft mbH & Co. KG, Schonefeld OT Waltersdorf (DE)

(72) Inventors: Jorge Rodriguez Prieto, Senden (DE); Klaus-Uwe Koch, Recklinghausen (DE); Kirsten Siebertz, Nidderau (DE)

(73) Assignee: Dritte Patentportfolio Beteiligungsgesellschaft mbH & Co., KG, Schonefeld OT Waltersdorf (DE)

(21) Appl. No.: 14/394,403

(22) PCT Filed: Apr. 16, 2013
(86) PCT No.: PCT/EP2013/057925

§ 371 Date: Oct. 14, 2014

(30) Foreign Application Priority Data
Apr. 16, 2012 (DE) 10 2012 007 823.4

(51) Int. Cl. C08L 75/04; C09D 175/04; B05D 3/04; C09J 175/04

(52) U.S. Cl. CPC C08L 75/04; C09J 175/04; C09D 175/04; B05D 3/04
USPC 427/378; 524/590; 523/322

(57) ABSTRACT

The invention relates to polymerizates that can be obtained by a) reacting at least one polyisocyanate with at least one polyol and optionally at least one radically curable monomer A with groups reactive toward isocyanate in at least one radically curable monomer B to form polyurethane particles having an average diameter of less than 40 nm, preferably less than 20 nm, and especially preferably less than 10 nm and an average number of radically curable functionalities in a range of 2 to 4, preferably 2 to 3, and b) emulsion polymerizing the product obtained under a). By means of the emulsion polymerization, larger cross-linked polyurethane/polymer hybrid dispersions are produced, in which the nanoparticles act as a connecting member between the polymer areas and the polyurethane components. This structure results in improved chemical resistance and significantly improved mechanical properties in comparison with traditional polyurethane dispersions, in which polyurethane nanoparticles are subsequently dispersed in polyacrylates, for example by means of an acetone method. Furthermore, the content of polyurethane in the polymer can be better controlled by means of this production method. The invention further relates to a method for producing such polymerizates and the use of such polymerizates as adhesives or coatings, in particular for textiles, or as paints, or for films and foils.

The present invention relates to polymers which are obtainable by reaction of at least one polyisocyanate with at least one polyol and at least one radically curable monomer A having isocyanate-reactive groups in at least one radically curable monomer B to form polyurethane particles having an average diameter of less than 40 nm, preferably less than 20 nm, and more preferably less than 10 nm, and an average number of radically curable functionalities in the range from 2 to 4, preferably 2 to 3, and subsequent emulsion polymerization of the resulting product. These polymers are suitable for application in adhesives, paints, or as a coating material, such as for application to materials in web form, e.g. textiles. Another aspect of the present invention relates to a process for preparing such polymers.

Polymer dispersions have acquired significant importance in numerous areas of application, such as coating, attaching, and bonding materials, or in the paint sector, since they can be processed, unlike solvent-based suspensions or solutions, without environmentally burdensome and expensive solvents. Thus, for example, EP 1 015 507 A1 describes aqueous polyurethane dispersions which can be used as paint for a number of substrates including wood or metals, glass, fabric, leather, paper, or plastic, and can be applied by methods such as dipping, flow coating, spraying, or similar methods. The aqueous carrier medium is removed from the coating, following application, by drying.

It is also known that the properties of polyurethane paints deriving from aqueous dispersions may be modified by incorporation into the dispersions of vinyl polymers, especially acrylic polymers. For example, the use of acrylic polymers may result in enhanced hardness on the part of the resultant paint coating. Such dispersions contain the polyurethane components and vinyl polymer components as a physical mixture.

Furthermore, various patent applications, such as U.S. Pat. No. 3,705,164, U.S. Pat. Nos. 4,198,330 and 4,318,833, describe processes in which a vinyl polymer is formed in situ by the polymerization of one or more vinyl polymers in the presence of a polyurethane, containing anionic side groups, in aqueous dispersion. An advantage of such formation of the vinyl monomer in situ is that its dispersion stability is in many cases higher and the properties of paints resulting therefrom are improved significantly by comparison with simple mixtures of the polyurethanes and vinyl polymers.

EP 0 666 275 describes water-based polyurethane/acrylic polymer dispersions which are suitable for films and film laminations and also for flexible packaging materials. These polyurethane/acrylic polymer dispersions are based on polyisocyanates which are functionalized with carboxylic acid side chains and so form anionic, water-dispersible prepolymers. These prepolymers can be subsequently modified via chain extension and reacted, by polymerization of the acrylate monomers in the mixture, to form completed polyurethane-acrylate polymer dispersions.

U.S. Pat. No. 5,371,133 describes a process for preparing polyurethane/acrylate or vinyl latexes for use in aqueous adhesives or paints, in which the urethane polymer has exclusively urethane linkages (i.e., no additional urea linkages).

EP 0 309 114 A1 discloses an aqueous polymer dispersion which contains a vinyl polymer and also a nonionic, water-dispersible polyurethane having polyethylene oxide side chains. The vinyl polymer is prepared by radical polymerization of at least one vinyl monomer in the presence of an aqueous dispersion of the polyurethane.

Lastly, U.S. Pat. No. 6,787,596 A1 discloses the stepwise preparation of a polyurethane predispersion containing a fraction of additional acrylate polymer. For this purpose, a polyurethane polymer containing acid functionalities is first of all prepared in aqueous dispersion, and is subsequently admixed with an acrylate component and polymerized likewise in aqueous phase.

Also known are nonaqueous polyurethane/acrylate dispersions (also referred to as 100% systems or reactive systems) comprising polyurethane particles in dispersion in a reactive solvent, which can be cured in a subsequent polymerization step. Such dispersions may be cured, for example, by means of UV radiation, and exhibit advantageous properties in applications such as adhesive bonds on glass, wood, metal, or plastic, or varnishing in the furniture and wood-floor sectors. For such nonaqueous dispersions, reference may be made, by way of example, to EP 1 910 436, which discloses polyurethane polymer particles in acrylate monomers as reactive diluents, the small size of the polyurethane particles leads to transparent products in tandem with good mechanical properties.

In many areas of application, however, where dispersions are applied extensively and in areas that are in some cases inaccessible, subsequent curing of radically curable monomers is hampered by difficulties, since the completeness of polymerization cannot be ensured in all cases. Unpolymerized monomers, though, constitute a problem, since the residual monomers may be released from the material over time and are often associated with considerable odour nuisance. This is a problem especially for textile applications, since the finished textiles come into contact with skin. Complete, full polymerization is also a problem with thick films.

Aqueous dispersions have further important advantages in application over solvent-thinable or 100% solids-containing dipsersions (100% nonvolatile fraction). For instance, dispersions based on high molecular mass polymers can be prepared and processed very effectively, since the viscosity of the dispersion is generally independent of the degree of polymerization. Following removal of the water by means of physical drying, very dry surfaces are obtained, a factor which for many coating operations is associated with advantages. Furthermore, in comparison to high-solids coating systems or adhesives (up to 100%), aqueous dispersions can be applied more reproducibly than thin films. Lastly, aqueous dispersions are advantageous for applications in which matt surfaces are desired, since “matting” is simple to bring about and gloss levels of less than 3E (60° measurement angle) can be set.

There exists accordingly a further demand for polymers, particularly for emulsion polymers, which display advantageous properties in applications, for example, in the adhesive sector, in the paint sector, or for coatings. There also exists a demand for polymers which are obtainable from relatively few components, in order to make production more economic.

The objectives described above are achieved with a polymer as claimed in claim 1. Dependent claims 2 to 9 specify advantageous embodiments of the polymer as claimed in claim 1. A process for preparing the polymer of the invention is specified in claims 10 to 17. Claims 17 to 19 relate to uses for which the polymer of the invention is suitable. In claim 1 only the monomer A, but not the monomer B as well, should be considered an optional component.

On account of the nanostructuring of the polyurethane particles, with a particle size of less than 40 nm, the polymers, in the form of adhesives, paints, or in coatings, have an advantageous transparency. Furthermore, adhesives produced from the polymers of the invention have a high impact strength, are easy to control in their elasticity, and have very high adhesive strength and robustness. In these applications, accordingly, the polyurethane particles fulfill the function of an impact modifier. Paints produced from the polymers of the invention additionally have a high resistance toward microscratches. Surprisingly, moreover, it has been found that the emulsion polymers of the invention, in comparison to corresponding emulsion polymers without polyurethane nanoparticles, are notable for improved adhesive strengths on various substrates and also for improved grain highlighting.

By “grain highlighting” in connection with the present invention it is meant the intensification of color that occurs when a wood surface is wetted by the coating material and which gives lasting emphasis to the wood grain (cf. Prieto/Keine, “Holzbeschichtung”, Coatings Compendien, Curt Vincentz-Verlag, Hannover, 2007).

In comparison to the solutions of polyurethane impact modifiers much in use to date, a feature of the polymer of the invention is that it is able to contain a higher fraction of polyurethane particles, based on the total weight of the composition, than in the case of solutions of polyurethanes in a curable solvent (reactive diluent). In the case of the latter, the fraction of polyurethane is limited by the sharp increase in viscosity in the case of high fractions. In the polymers of the invention, accordingly, a high fraction of polyurethane as an impact modifier can be achieved in conjunction with good handling and processing properties. In addition, as a result of the functionalization with monomers having isocyanate-reactive groups, the polyurethane particles are bonded covalently to the emulsion polymer, since these monomers ensure that the particles are incorporated into the resultant polymer during the emulsion polymerization. As a result, emulsion polymer particles can be produced that exhibit a uniform morphology. The polyurethane particles consist of polyurethanes which are prepared by reaction of polyisocyanates with polyols and optionally a monomer(s) A having groups that are functional toward isocyanates. Polyisocyanates in the context of the invention refer to low molecular mass compounds which contain two or more isocyanate groups in the molecule. In the present invention, diisocyanates are used with preference. Additionally, however, polyisocyanates having three or more isocyanate groups may be added, in order to set a suitable property spectrum of elongation at break and tensile strength. The higher the fraction of compounds having three or more functionalities, the higher the tensile strength. In order to obtain a suitable value for elongation at break strength, the fraction of polyisocyanates having three or more isocyanate groups should, however, be not greater than about 10 wt %, preferably not greater than 5 wt %, based on the total mass of polyisocyanates.

As far as the selection of the polyisocyanates is concerned, the present invention is not subject to relevant restrictions. The polyisocyanates which can be used in the present invention include, especially, toluene 2,4-diisocyanate, toluene 2,6-diisocyanate, diphenylmethane 4,4′-diisocyanate(methylenediphenyl 4,4′-diisocyanate, MDI), dicyclohexyl 4,4′-diisocyanate, methylenedicyclohexyl 2,4′-diisocyanate, methylenedicyclohexyl 4,4′-diisocyanate, meta- and para-tetramethylxylene diisocyanate, 3-isocyanato-methyl-3,5,5-trimethylcyclohexyl isocyanate (isophorone diisocyanate), hexamethylene isocyanate, naphthylene 1,5-diisocyanate, dianisyl diisocyanate, di(2-isocyanatoethyl) bicyclo[2.2.1]hept-5-ene-2,3-dicarboxylate, 2,2,4- and 2,4,4-trimethylhexamethylene diisocyanate (TMDI), triphenylmethane 4,4′,4″-tri-isocyanate, tris(4-isocyanatophenyl) thiophosphate, and mixtures thereof.

Suitable polyisocyanates may also be obtained, for example, through the reaction of polyhydric alcohols with diisocyanates or through the polymerization of diisocyanates (e.g., isocyanurate structure). Also suitable for use are polyisocyanates which are preparable by reaction of hexamethylene diisocyanate with small amounts of water. These polyisocyanates contain urea groups.

Besides polyisocyanates, small amounts of monoisocyanates may also be used in the reaction of the polyols with the polyisocyanates, and act as chain transfer agents for the polyisocyanate. It is nevertheless preferred if the amount of the additional monoisocyanates is not more than 10 mol %, especially not more than 5 mol %, based on the total amount of the isocyanate functionalities.

The polyol is preferably a high molecular weight polyol with a random molar mass distribution. In this context, a “high molecular weight polyol” for the purposes of the present invention is a polyol having two or more hydroxyl groups, the weight-average molecular weight of the high molecular weight polyol being in the range from >500 to about 20 000 g/mole. Preferably it is within the range from >500 to 15 000 g/mole, especially in the range from >500 to 10 000 g/mole, and very preferably in the range from >500 to 5000 g/mole, measured by gel permeation chromatography.

Where molecular masses are referred to in the text above, they should be determined for the purposes of the present invention using appropriate standards, via GPC.

Exemplary of high molecular weight polyols are the polyether polyols. Polyether polyols are polyalkylene ether polyols of the structural formula

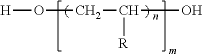

in which the substituent R is hydrogen or an alkyl group having 1-5 carbon atoms, including mixed substituents, and n typically is an integer from 2-6 and m is 2 to 100 or even higher. Preferred polyether polyols are the poly(oxytetramethylene) glycols (i.e., polytetrahydrofurans), poly(oxyethylene) glycols, poly(ox-1,2-propylene) glycols, and the reaction products of ethylene glycol with a mixture of propylene 1,2-oxide, ethylene oxide, and alkyl glycidyl ethers.

Likewise possible for use as high molecular weight polyols are medium molecular mass copolyester diols, or linear copolyesters having terminal primary hydroxyl groups. Their weight-average molecular weight is preferably 3000-5000 g/mol. Such polyols are obtainable by esterification of an organic polycarboxylic acid or derivative thereof with organic polyols and/or an epoxide. Generally speaking, the polycarboxylic acids and polyols are aliphatic or aromatic dibasic acids and diols.

Used preferably as diol in the copolyester diol are alkylene glycols, such as ethylene glycol, neopentyl glycol, or else glycols such as bisphenol A, cyclohexanediol, cyclohexanedimethanol, diols derived from caprolactone, for example the reaction product of epsilon-caprolactone and ethylene glycol, hydroxy-alkylated bisphenols, polyether glycols, such as poly(oxytetramethylene) glycol. Polyols of higher functionality may also be used. They comprise, for example, trimethylolpropane, trimethylolethane, pentaerythritol, and also higher molecular weight polyols, such as those prepared by oxyalkylation of low molecular mass polyols.

Employed as acid component in the copolyester diol are, preferably, monomeric carboxylic acids or carboxylic anhydrides having 2 to 36 carbon atoms per molecule. Examples of acids which can be used include phthalic acid, isophthalic acid, terephthalic acid, tetrahydrophthalic acid, decanedioic acid, and dodecanedioic acid. The polyesters may contain small amounts of monobasic acids, such as benzoic acid, stearic acid, acetic acid, and oleic acid, for example. Likewise possible for use are higher polycarboxylic acids, such as trimellitic acid.

Another class of high molecular weight polyols which can be used in accordance with the invention are the polyesters of the lactone type. They are formed by the reaction of a lactone, such as epsilon-caprolactone, for example, with a polyol. The product of a lactone with an acid-containing polyol may also be used.

In one especially preferred embodiment, the polyol for the polyurethane (meth)acrylate particles comprises a mixture of at least one high molecular weight polyol and at least one low molecular weight polyol.

A low molecular weight polyol is understood in accordance with the invention to be a compound which has two or more hydroxyl functionalities and possesses a molar mass of 50 to 500 g/mole and preferably 50-250 g/mole. The molecular weight may be uniform (single compound), or it may be randomly distributed (oligomer); in the latter case, the molecular weight should be understood as the weight-average molecular weight. A preferred low molecular weight polyol is one with a uniform molecular weight, with preference being given to the aliphatic diols having 2 to 18 carbon atoms, such as ethylene glycol, 1,2-propanediol, 1,3-propanediol, 1,2-butanediol, 1,4-butanediol, 1,2-hexanediol, and 1,6-hexanediol, for example, and to the cycloaliphatic polyols, such as 1,2-cyclohexanediol and cyclohexanedimethanol. Also possible for use are polyols having ether groups, such as diethylene glycol, triethylene glycol, and dipropylene glycol. Exemplary of low molecular weight polyols having more than two hydroxyl groups are trimethylolmethane, trimethylolethane, trimethylolpropane, glycerol, and pentaerythritol. Most preferred for use as low molecular weight polyol are 1,4-butanediol and 1,3-propanediol. In another embodiment, 1,4-butanediol or 1,3-propanediol is used as low molecular weight polyol. The molar ratio of the OH groups of the low molecular weight polyol to the OH groups of the high molecular weight polyol is appropriately in the range from 0.3 to 1.2.

Additionally to polyols, in the reaction of the polyols with the polyisocyanates, it is also possible to use small amounts of monohydric alcohols, which, like monoisocyanates, act as chain transfer agents for the polyisocyanate. In that case it is preferred, however, if the amount of the additional monoalcohols is not more than 10 mol %, especially not more than 5 mol %, calculated on the basis of the total amount of the OH functionalities, based on polyols and monoalcohols.

Additionally to the polyols, it is also possible to employ polythiols, polyamines, or alkanolamines. Thiols which can be used advantageously are, especially, aliphatic thiols, including alkane-, alkene-, or alkyne-thiols, which have at least two or more —SH groups, especially polythiols such as 2,2′-oxytris(ethanethiol) and di- and tri-mercaptoproprionate esters of poly(oxyethylene)diol, thiodiglycols, and triols. A wide spectrum of compounds can also be used as polyamines. Examples of suitable linear diamides include, especially, Jeffamine™ such as the polyoxypropylenediamines which are available commercially as Jeffamine™ D230, Jeffamine™ D400, and Jeffamine™ D2000, and also as Jeffamine™ EDR-148 (a triethylene glycol diamine). Examples of alkyl-substituted branched diamines are 2-methyl-1,5-pentanediamine, 2,2,4-trimethyl-1,6-hexanediamine, and 2,4,4-trimethyl-1,6-hexanediamine. Cyclic diamines may also be used, such as, for example, isophoronediamine, cyclohexanediamine, piperazine, and 4,4′-methylenebis(cyclohexylamine), 4,4′-, 2,4′-, and 2,2′-diaminodiphenylmethane, 2,2,4-trimethyl-1,6-hexanediamine, 2,4,4-trimethyl-1,6-hexanediamine, and polyoxypropylenediamines. Alkanolamines are compounds which have amine functionalities and hydroxyl functionalities. Further examples of alkanolamines are 2-(methylamino)ethanol and N-methyldiethanolamine. Suitable examples of compounds which have an amino group and a further group selected from amino and hydroxyl are diamines, alkanolamines, and amine-terminated polyamides or polyethers. Use may likewise be made of mixtures of such compounds. It is preferred if the amount of the polyamines, polythiols, and alkanolamines is not more than 50 mol %, especially not more than 20 mol %, and more preferably not more than 10 mol %, based on the total amount of the OH, NH, and SH functionalities in the isocyanate-reactive compounds.

Furthermore, urethane particles having especially advantageous properties are obtained if the molar ratio of the isocyanate groups from the polyisocyanate to the hydroxyl groups from the polyol is in the range from 1.03 to 1.7.

In the polymers it is appropriate if the fraction of the polyurethane particles, based on the total weight of the organic components in the polymer, is about 5 to 70 wt %, preferably 20 to 60 wt %, and more preferably 30 to 50 wt %.

In the polymers, the polyurethane particles may be functionalized with radically curable monomers, especially with vinylic monomers A. These are preferably (meth)acrylates. These polyurethane particles are obtainable by reaction of at least one polyisocyanate with at least one polyol and with at least one nucleophilically functionalized monomer A, especially a nucleophilically functionalized (meth)acrylic ester.

The term “nucleophilically functionalized (meth)acrylic ester” in the context of this invention means a (meth)acrylic ester which in its radical originating from the alcohol carries a nucleophilic functional group which can be reacted wholly or partly with free isocyanate groups. This group is preferably a hydroxyl, amine, or mercapto functionality, more preferably a hydroxyl functionality. Last-mentioned nucleophilically functionalized (meth)acrylic esters are also designated “hydroxy-functional (meth)acrylic esters”. By virtue of this composition, polyurethane particles are obtained which carry acrylate functionalities on their surface, and so enter into an interaction with the radically curable monomers in the dispersion. Such particles are also referred to as polyurethane (meth)acrylates.

The term “polyurethane (meth)acrylate” in the context of this invention means a polyurethane some or all of whose free terminal isocyanate groups have been reacted with a nucleophilically functionalized (meth)acrylic ester. In this case, the isocyanate groups react with the nucleophilic group of the nucleophilically functionalized (meth)acrylic ester, e.g., hydroxy-, amino-, or mercapto-, and terminal, ethylenically unsaturated functionalities are formed which derive from (meth)acrylates. The expression (meth)acrylic acid here denotes methacrylic acid or acrylic acid, and also mixtures of these acids. The nucleophilically functionalized methacrylic esters which react with the free isocyanate groups of the polyurethane, and therefore “cap” them, are also referred to as “capping reagents”.

Especially preferred nucleophilically functionalized (meth)acrylic esters are hydroxy-functional (meth)acrylic esters. A “hydroxy-functional (meth)acrylic ester” in accordance with the invention is to be understood to be a (meth)acrylic ester which in the radical hailing from the alcohol, after the esterification with the (meth)acrylic acid, still carries at least one hydroxyl functionality. Alternatively, the ester is that of a (meth)acrylic acid and a diol or polyol, the diols being preferred.

One especially preferred group of the “hydroxy-functional (meth)acrylic esters” are the hydroxyalkyl (meth)acrylic esters. Hydroxyalkyl (meth)acrylic esters which can be used in accordance with the invention are monoesters of (meth)acrylic acid with dihydric aliphatic alcohols. These compounds are known in the art. They may be obtained, for example, by the reaction of (meth)acrylic acid with oxiranes.

As far as the fraction of the nucleophilically functionalized (meth)acrylic esters is concerned, there are no relevant restrictions within the present invention. It ought to be ensured, nevertheless, that the polyurethane nanoparticles have OR average at least one vinyl functionality. The average functionality of radically curable groups per nanoparticle is preferably in the range from about 2 to 4, especially in the range from 2 to 3. In one preferred embodiment, the fraction of the nucleophilic groups in the vinylic monomer to be incorporated into the particles, based on the total amount of all functional groups in the precursors of the polyurethane, i.e., especially, the OH groups from the polyols, is in the range from about 0.1 to 70%, especially about 25 to 50%. In another embodiment, the fraction of the functional groups, based on the total amount of all functional groups in the precursors of the polyurethane, is about 0.1 to 10%, especially 0.5 to 7%.

While the applicant in this respect is not relying on any particular theory, it is assumed that the functionalized nanoparticles form “nanocenters”, which are integrated into the polymer (i.e., copolymerized) that is formed during the polymerization of the radically curable monomers. Conventional acrylate/polyurethane dispersions generally take the form of physical mixtures, in which there are essentially no covalent bonds between the polyurethane fractions and acrylates (as a result of chain transfer, linkage of acrylates and polyurethanes may also occur to a small extent during the polymerization of the acrylate fractions). As a result of the functionalization of the polyurethane particles, however, the particles are integrated at least fractionally into the acrylate matrix. The mechano-technological properties are thereby improved significantly by comparison with polyacrylate/polyurethane hybrids without covalent linkage.

In a further embodiment, excess isocyanate functionalities in the polyurethane particles may also be reacted with monohydric alcohols, such as methanol, ethanol, n- or isopropanol, butanol, etc., so that the resulting polyurethane particles have no groups reactive toward the radically curable monomer B. In certain cases, such polyurethane particles may contribute to further stabilization of the emulsion. Where monohydric alcohols are used for the conversion of remaining isocyanate functionalities in the polyurethane particles, the quantitative restrictions to be applied are those for vinylic monomers for incorporation into the particles, rather than the above quantitative restrictions for monohydric alcohols as chain transfer agents.

The functionalized polyurethanes which are subsequently subjected to emulsion polymerization with radically curable monomers B possess an average molecular weight Mn of about 3000 g/mol to 800 000 g/mol and preferably from 3000 g/mol to 600 000 g/mol. The functionalized polyurethanes preferably have high average molecular weights, since this is advantageous for the chemical stability of the particles. Additionally, functionalized polyurethanes with a high molecular weight also feature better mechano-technological properties, such as improved adhesive strength, bonding capacity, tensile strength, and tear resistance, and also an excellent stretchability. For this reason, the average molecular weight of the functionalized polyurethanes is preferably in the range from 100 000 to 800 000 g/mol, especially 200 000-600 000 g/mol.

The polymers of the invention are obtainable by emulsion polymerization of the above-described polyurethane particles, having radically curable functionalities, with at least one radically curable monomer B. The polyurethane particles here have an average diameter of less than 40 nm, preferably an average diameter of less than 20 nm, and especially an average diameter of less than 10 nm. While the applicant is not relying on any particular theory, an effect of the low particle size is that the resulting polymer has an advantageous transparency. Depending on the polyols and polyisocyanates incorporated into the polyurethane particles, the polyurethane particles may also function as an emulsifier for radically curable monomers in an emulsion polymerization of these monomers, without any need for the polyurethane to be modified with anionic side groups.

As far as the radically curable monomers B to be used are concerned, the present invention is not subject to any relevant restrictions. It is nevertheless preferred if a vinyl monomer is used as radically curable monomer B, especially styrene and substituted styrenes, such as substituted styrenes having an alkyl substituent in the side chain, such as alpha-methylstyrene and alpha-ethylstyrene, for example, substituted styrenes having an alkyl substituent on the ring, such as vinyltoluene, for example, halogenated styrenes, such as monochlorostyrenes, dichlorostyrenes, tribromostyrenes, or tetrabromostyrenes, for example.

Other radically curable monomers B which can be used advantageously are vinyl acetate, vinyl chloride, and vinylidene chloride. A preferred radically curable monomer is vinylidene chloride (1,1-dichloroethylene). In another preferred embodiment, the radically curable monomer B comprises dienes, especially isoprene, butadiene, or a mixture thereof.

In other cases, it is preferred if the radically curable monomer B comprises (meth)acrylates. This term refers, in the context of the invention, both to methacrylates and to acrylates. The (meth)acrylates may have one or more double bonds. (Meth)acrylates which have two or more double bonds are referred to in the context of the invention as polyfunctional (meth)acrylates, and serve especially to set a desirable degree of crosslinking. The radical in the (meth)acrylates that hails from the alcohol may contain heteroatoms, in the form of ethers, alcohols, carboxylic acids, esters, or urethane groups, for example.

The radical curable monomer B may be used in the form of an individual compound or of two or more radical curable monomers.

Preferred radically curable monomers B in the context of the invention include alkyl (meth)acrylates which derive from saturated alcohols, such as methyl (meth)acrylate, ethyl (meth)acrylate, isopropyl (meth)acrylate, n-propyl (meth)acrylate, n-, iso- or tert-butyl (meth)acrylate, pentyl (meth)acrylate, n-hexyl (meth)acrylate, n-octyl (meth)acrylate, n-decyl (meth)acrylate, isooctyl (meth)acrylate, tetradecyl (meth)acrylate, phenoxyethyl (meth)acrylate, allyl (meth)acrylate, glycidyl (meth)acrylate, neopentyl (meth)acrylate, isobornyl (meth)acrylate, hexanediol diacrylate (HDDA), dipropylene glycol diacrylate (DPGDA), tripropylene glycol diacrylate (TPGDA), cyclohexyl (meth)acrylate, tert-butyl (meth)acrylate, tetrahydrofurfuryl (meth)acrylate, mono-2-(meth)acryloylmethyl maleate, 7,7,9-trimethyl-4,13-dioxo-3,14-dioxa-[2-diazahexanedecane-1,16-diol di(meth)acrylate, 3-[2-((meth)-acryloyloxy)ethoxycarbonyl]propionic acid, or mixtures thereof. Most preferred as radically curable monomers B are methyl acrylate (MMA), 2-phenyloxyethyl methacrylate (POEMA), isobornyl acrylate (IBOA), 2-ethylhexyl acrylate (2-EHA), and tetrahydrofurfuryl methacrylate (THFMA).

Furthermore, vinyl ethers may also be copolymerized, examples being 2-ethylhexyl vinyl ether, 4-hydroxybutyl vinyl ether, butanediol divinyl ether, cyclohexyl vinyl ether, diethylene glycol divinyl ether, dodecyl vinyl ether, isobutyl vinyl ether (stab. 0.1% DEA), N-butyl vinyl ether, octadecyl vinyl ether, triethylene glycol divinyl ether, and tert-butyl vinyl ether.

In the emulsion polymerization with which the polymer of the invention is obtainable, conventional emulsifiers may be added, such as, for example, alkyl sulfate salts such as sodium dodecyl sulfate, alkyl-diphenyl oxide disulfonates, ethoxylates of secondary alcohols, ethylene oxide/propylene oxide copolymers, diphenol ethoxylates, or polyether phosphate esters. Other conventional emulsifiers which may be included in emulsion polymerizations are familiar to the skilled person. Polymerizable emulsifiers, such as sodium vinylsulfonate, for example, may likewise be used.

The addition of an emulsifier is not mandatory. When using suitable polyols (for example, long-chain polyoxyalkylene polyols) in the polyurethane, the polymerization can be carried out in the absence of additional emulsifiers, since an emulsifying effect is ensured on the one hand by the nanostructure of the polyurethane particles and on the other hand by the interaction of the polyol chains with water. Alternatively, the use of additional emulsifiers may be reduced by comparison with conventional emulsion polymerizations.

The polymerization is set off appropriately by conventional polymerization initiators, which are preferably water-soluble and form free radicals after absorption of energy. Examples of such initiators include hydrogen peroxide, sodium persulfate, potassium persulfate, and ammonium persulfate, or corresponding peroxodisulfates, and also tert-butyl hydroperoxide; the catalyst is to be used appropriately in amounts in the range from 0.01 wt % to 3 wt %, preferably 0.01 to 1 wt %, based on the total solids content of the emulsion.

The initiator used may be a single compound or a combination with reducing agents, such as sodium formaldehydesulfoxylate, iron salts, sodium dithionite, sodium hydrogensulfite, sodium sulfite, or sodium thiosulfate, which act as redox catalysts and may be used in amounts in the range from 0.01 to 3 wt %, preferably 0.01 to 1 wt %, based on the total solids content of the emulsion. The radical initiators may be added to the aqueous emulsion completely at the beginning of the polymerization, or may be added in a plurality of portions.

The polymerization is carried out in general at a pH of from 2 to 7, preferably 3 to 5. In order to remain within this pH range it may be appropriate to operate in the presence of a buffer system, such as alkali metal acetates, alkali metal carbonates, or alkali metal phosphates, for example. It is likewise possible for transfer agents to be added, such as mercaptans, aldehydes, chloroform, ethylene chloride, and trichloroethylene.

In relation to its fraction of radically curable monomers B, the polymer may have functional groups, especially hydroxyl groups or carboxyl groups, which are available for subsequent crosslinking. Such crosslinking may take place through self-crosslinking or through addition of external crosslinkers such as melamine resins, polyaziridines, polycarbodiimides, hydrophobized and/or hydrophilic polyisocyanates.

The present invention also relates to a process for preparing a polymer as described above, comprising a) the reaction of at least one polyisocyanate with at least one polyol and optionally at least one radically curable monomer A having isocyanate-reactive groups in at least one radically curable monomer B to form polyurethane particles having an average diameter of less than 40 nm, preferably less than 20 nm, and more preferably less than 10 nm, and an average number of radically curable functionalities in the range from 2 to 4, preferably 2 to 3, and b) emulsion polymerization of the product obtained under a).

Relative to comparable processes from the prior art, it has emerged as advantageous if the polyisocyanate in the radically curable monomer B, which in this case acts as reactive diluent, is reacted with the polyols and the radically curable monomer A having an isocyanate-reactive functionality. In this case, the radically curable monomer acting as reactive diluent appropriately has no functional groups which react with isocyanates. An advantage of this approach is that on the one hand there is no need to use an additional solvent. On the other hand, the preparation of polyisocyanates in water is always associated to a minor extent with hydrolysis of the isocyanates, a phenomenon which, via the formation of urea linkages in the resultant polymer, may have adverse consequences for its properties, especially in less favorable resistances under outdoor weathering or UV radiation. As a result of the polymerization in the radically curable monomer, this side-reaction is prevented, and the properties of the polyisocyanate can be more conveniently set.

The reaction a) is carried out preferably in a stirred tank at a peripheral stirrer speed of at least 5 m/s, the ratio of stirrer diameter to vessel diameter being 0.3 to 0.80, and the distance of the stirrer from the vessel base being 0.25 to 0.5 times the stirrer diameter.

The geometry of the stirrer and its speed may be designed by the skilled person expertly, on the basis of the information above. It has emerged as being appropriate, however, if the peripheral stirrer speed is within the range from 100 to 500 rpm, preferably 150 to 300 rpm. In accordance with the present invention, alternatively, the process may be advantageously designed with the peripheral stirrer speed being at least 12 m/s. It is preferred, moreover, for the stirrer used to be a dispersing disk, a Turrax stirrer (e.g., Unidrive X 1000 D CAT, from Zipperer Gmbh, with type G20 20 mm V shaft), or a KPG stirrer.

In the emulsion polymerization with which the polymer of the invention is prepared in step b), it is appropriate to polymerize the radically curable monomer B with the aid of an initiator, as set out above.

It is also advantageous if the reaction of the polyisocyanate with the polyol in step a) of the process is performed in the presence of a catalyst, which may be selected from tertiary organic amines and/or organotin compounds. Especially the use of dibutyltin laurate as catalyst is especially appropriate.

The particle size of the secondary particles, obtainable from the emulsion polymerization, in the emulsion polymers of the invention is preferably in the range from about 50 to about 150 nm, more preferably about 70 to about 120 nm. The polyurethane nanoparticles are incorporated in the form of inclusions in these secondary particles.

Polymers obtainable by means of emulsion polymerization have a very great market importance and are established in particular for use in adhesives, textiles, and coatings. By the process of the present invention, such polymers may be prepared much more easily, with less cost and complexity, and in a more targeted way; especially, the use of organic solvents such as acetone can be dispensed with. Another aspect of the process described above, therefore, is the forgoing of the use of organic solvents, especially of acetone.

By virtue of the bonding strength, the polymers of the invention are particularly suitable as adhesives, among other uses. Accordingly, a further aspect of the present invention relates to the use of a polymer as described above as an adhesive, especially as a dispersion-based adhesive. For the formulation of the adhesive, the polymer may be used in pure form (i.e., as described above), or may be admixed with further reactive adhesives on an aqueous basis or with reactive adhesives on a reactive bonding basis, especially on a (meth)acrylate basis. Further provided by the present invention is the use of the polymers as a layer of adhesive on adhesive tapes.

Another aspect of the present invention relates to the use of the above-described polymers as paint or constituent of a paint.

Polymers of the invention may be used, for example, in wood coating or furniture coating as a primer and/or as topcoats. Within this sector, for clear varnish systems, maximum transparency (i.e., no veiling of the wood grain) is the target, in order to obtain very good grain highlighting. The term “grain highlighting” refers to the intensification of color which occurs when the wood surface is wetted by the coating material, and which lastingly emphasizes the wood grain. When inorganic nanoparticles are used, clouding is frequently visible at and above an active concentration.

The polymers of the invention and aqueous paints produced from them may be used, furthermore, to coat primed or unprimed plastics such as, for example, ABS, AMMA, ASA, CA, CAB, EP, UF, CF, MF, MPF, PF, PAN, PA, PC, PE, HDPE, LDPE, LLDPE, UHMWPE, PET, PMMA, PP, PS, SB, PUR, PVC, RE, SAN, PBT, PPE, POM, PUR-RIM, SMC, BMC, PP-EPDM, and UP (short codes according to DIN 7728 T1). The purpose of coating plastics is to improve the adhesive strength and scratch resistance of the paint systems used. Furthermore, the paint systems are required to have a certain elasticity, in order to remain crack-free at high and low temperatures under impact stress (e.g. fenders).

Another field of application is that, for example, of PVC and linoleum flooring. For embossable linoleum floors, the prior art employs UV-curing polyurethane dispersions. In such applications, the polymers of the invention are used in order to improve the abrasion resistance properties and/or lifetime.

Automobile paints (primers, surfacers, metallic basecoats, topcoats, or clearcoats) are applied primarily by a spraying process. Generally speaking, such paints are glossy. Such high-grade surfaces are expected to have a clear, brilliant appearance. The use of inorganic and nanoscale fillers or nanoparticles in clearcoats leads to slightly milky/cloudy phenomena. This effect is referred to as “haze”. The haze occurs only with highly glossy surfaces. In connection with automobile paints, the polymers of the invention can be used in order to prevent such haze, and, furthermore, for improvements in “wash brush resistance” with respect to microscratching.

In the segment of industrial paints, a wide variety of crosslinking techniques are used (one-component oxidative, one-component melamine resin crosslinking, one-component blocked polyisocyanates, two-component polyisocyanate, one-component self-crosslinking, one-component physically drying). Currently dominant within this field of application are solvent-thinable paints. Waterborne paints, however, are steadily gaining in importance. The polymers of the invention can be functionalized in such a way that the abovementioned crosslinking methods are possible. They are compatible, accordingly, given appropriate formulation, with melamine resins and with blocked and nonblocked polyisocyanates.

Other important fields of application are one-coat primers, one-coat paints, and clearcoat systems. The polymers of the invention are likewise suitable for anticorrosion paints. The primary dispersions (polyacrylates) used in the prior art have the disadvantage that they cannot be used to obtain higher degrees of gloss.

Lastly, dispersions of the invention may be processed further to form sheets. Of particular interest in this context are sheets based on polyvinylidene chloride, especially, which can be used as barrier sheets for foods and drug packaging. A further territory of application for the polymers of the invention is that of anticorrosion applications.

Depending on their use, the above-described paints and adhesives may be formulated with customary adjuvants. Exemplary, though not exhaustive, for such adjuvants are coalescence agents such as ethyldiglycol, defoamers, based for example on polyethersiloxane copolymers, wetting agents, based for example on polyether-modified siloxanes, and thickeners, based for example on polyurethanes. It may be appropriate, moreover, to set the pH of the emulsion such that the resulting emulsion enjoys maximum stability. A suitable pH in connection with the present invention is in the range from 7 to 9.

A further aspect of the present invention relates to the application of a polymer of the invention to a textile.

Lastly, a further aspect of the present invention relates to the use of polymers of the invention for producing films and casting sheets, in which case the polymers can be used either alone or as a mixture with further components.

The uses described above may involve the application of the polymers of the invention to a corresponding substrate and, optionally, curing of the dispersion by means of physical drying. This may be done, for example, by application of a reduced pressure or by heating. The skilled person is familiar with further alternatives for physical drying, which require no more detailed elucidation here.

In numerous areas of application, the polymers of the invention described above are notable for advantageous properties, especially a desirable transparency, a high notched impact strength and elongation at break, and a ready adhesiveness to materials such as PVC, glass, wood, and metal.

In the context of the invention, the degree of crosslinking may be set advantageously so as to ensure a sufficient flowability. Furthermore, as a result of the possible high flexibility in terms of the acrylates, methacrylates, diols, and diisocyanates that can be used, it is readily possible to realize properties desirable for the specific end application. Moreover, through selection of suitable starting materials, it is possible to avoid an addition of dispersion stabilizers. On the basis of these properties, such polymers are of very great interest in diverse industrial applications.

The present invention is illustrated in more detail below, by a number of examples, which, however, are not authoritative in determining the scope of protection of the present invention.

### EXAMPLES

### Example 1

### Synthesis of the Primary Particles in the Reactive Diluent

The experiments were carried out in a vacuum Kreis-Dissolver model V KDV 30-3,0 from Niemann (D-49326 Melle). The container size, disk diameter, rotary speed, and temperature used in each case are reported in table 1.

The synthesis was carried out as follows: on a top pan balance, 0.2692 mol of diisocyanate (TMDI) and 2.31 mol of (reactive) diluent (methyl methacrylate (MMA), or vinylidene chloride (VCD)) are weighed out and stirred at the stated rotational speed for 2 hours at 60° C. or 20° C. Then 0.072 mol of polyol (Lupranol VP 9358 (PPG), PTHF 2000, Dynacoll 7250), 0.085 mol of chain extender (1,4-butanediol), and optionally 1.36 mol of (reactive) diluent (MMA, VCD) were added. The mixture was gently heated and then introduced dropwise into the reactor over 1 hour with the aid of a dropping funnel heated at 60° C. Added subsequently to the reaction mixture was 0.728 mmol of catalyst (DBTDL or DABCO), followed by stirring at 60° C./20° C. for one hour more. This is followed by determination of the free isocyanate groups according to DIN EN 1242.

For the “capping”, an amount of capping reagent (hydroxyethyl methacrylate (HEMA), methanol, or hydroxyethyl acrylate (HEA)) equimolar with the isocyanate content ascertained is added, and the mixture is cooled to 23° C.

After the synthesis and the endcapping, 25 ppm of 5% strength hydroquinone solution were added as stabilizer.

TABLE 1

| | Sample 1 | | Sample 2 | | Sample 3 | | Sample 4 | | Sample 5 | | Sample 6 | |
|---|---|---|---|---|---|---|---|---|---|---|---|---|
| Reactor | 4 | L | 4 | L | 2 | L | 2 | L | 2 | L | 2 | L |
| rpm | 4300 | | 4300 | | 5700 | | 5700 | | 5700 | | 5700 | |
| Disk | 80 | mm | 80 | mm | 60 | mm | 60 | mm | 60 | mm | 60 | mm |
| Temp | 60° | C. | 60° | C. | 20° | C. | 20° | C. | 20° | C. | 20° | C. |
| I | | | | | | | | | | | | |
| TMDI | 139.65 | g | 139.65 | g | 14 | g | 14 | g | 14 | g | 14 | g |
| MMA | 570.6 | g | 570.6 | g | | | | | | | | |
| VCD | | | | | 719.68 | g | 719.68 | g | 719.68 | g | 719.68 | g |
| II | | | | | | | | | | | | |
| Dynacoll | 977.01 | g | 977.01 | g | 34.96 | g | 34.96 | g | 34.96 | g | 33.92 | g |
| 1,4- | 18.9 | g | 18.9 | g | 1.88 | g | 1.88 | g | 3.05 | g | 3.05 | g |
| butane- | | | | | | | | | | | | |
| diol | | | | | | | | | | | | |
| VCD | | | | | 423.72 | g | 423.72 | g | 423.72 | g | 423.72 | g |
| III | | | | | | | | | | | | |
| DBTDL | 1.14 | g | 1.14 | g | | | | | | | | |
| DABCO | | | | | 0.06 | g | 0.06 | g | 0.06 | g | 0.06 | g |
| % NCO | 1.09 | | 1.09 | | 0.478 | | 0.478 | | 0.478 | | 0.396 | |
| IV | | | | | | | | | | | | |
| HEMA | 65 | g | | | | | | | | | | |
| MeOH | | | 15.9 | g | | | | | | | | |
| HEA | | | | | 3.68 | g | 3.95 | g | 3.68 | g | 3.045 | g |
| Yield | 2 | kg | 2 | kg | 1.12 | kg | 1.11 | kg | 1.12 | kg | 1.12 | kg |

On storage of samples 3 to 6 at 23° C. it was observed that a slight sediment is formed in the clear, slightly viscous product. The sediment is much smaller than the polyurethane content (5 wt %) of the samples. The VDC-based products with 5% polyurethane content were preparable with different polyols.

### Example 2

### Preparation of the Emulsion Polymers

In a dropping funnel, the emulsion of the monomers is produced by stirring. Weighed out for this purpose are 97.44 g of water, 13.33 g of sodium dodecyl sulfate (15%), and 200 g of the respective starting material (emulsion feed). In a second dropping funnel, the initiator is dissolved in water. Weighed out for this purpose are 39.00 g of water and 1.0 g of sodium peroxodisulfate (initiator). The reactor, flushed with nitrogen, is then charged with 55.90 g of water, 15.54 g of emulsion feed, and 4 g of initiator feed. This mixture is then heated to 85° C. with stirring. This sets off the polymerization. After 5 minutes at 85° C., the contents of the two dropping funnels are introduced into the reactor at a uniform rate over 1.5 hours with stirring. The temperature must be maintained very precisely at 85° C.+/−1° C. by cooling. After the end of feeding, the temperature is held at 85° C. for a further hour, after which cooling is carried out.

In the synthesis, about 400 g of a 50.2% aqueous dispersion and 5 g of coagulum have been produced. Through the amount of emulsion in the initial charge, the particle size has been set at 190 nm diameter, with a narrow distribution. If a different particle size is required, it is possible to amend the initial-charge amount for the initial polymerization, or to amend the emulsifier concentration, or to introduce additional emulsifier in the initial charge.

The conditions for various emulsion polymerizations are set out in table 2 below.

TABLE 2

| | Comparative | | |
|---|---|---|---|
| | sample | Sample 7 | Sample 9 |
| Reactor | 1 L | 1 L | 1 L |
| rpm | 200 | 200 | 200 |
| Disk | KPG stirrer | KPG stirrer | KPG stirrer |
| Temp | 85° C. | 85° C. | 85° C. |
| I | | | |
| Water | 97.44 g | 97.44 g | |
| Sodium dodecyl | 13.33 g | 13.33 g | |
| sulfate | | | |
| MMA | 200 g | | |
| 80% MMA/20% | | 200 g | |
| sample 1 | | | |
| 40% butyl acrylate/ | | | 200 g |
| 60% sample 1 | | | |
| II | | | |
| Water | 39 g | 39 g | 39 g |
| Sodium peroxo- | 1 g | 1 g | 1 g |
| disulfate | | | |
| III | | | |
| Water | 55.9 g | 55.9 g | 55.9 g |
| 5% I | 15.54 g | 15.54 g | 15.54 g |
| 5% II | 4 g | 4 g | 4 g |
| Yield | 370 g | 370 g | 386 g |
| pH | 2 | 2 | 1-2 |

In the case of the comparative sample and of the two inventive samples, a viscous but flowable, milk-colored liquid was obtained. Small amounts of (polymeric) solid (a few g) formed were readily removable and caused no problems at the scale described.

From the aqueous dispersions of the comparative sample and of the inventive samples 8 and 9, paint formulas were assembled and corresponding paint films were produced. Table 3 lists the formulations employed (weight fractions, 100%). In order to increase the stability and compatibility of the dispersions used, the dispersions were adjusted with ammonia to a pH of 8-9.

TABLE 3
Paint formulations produced

| Raw materials | Paint 1 | Paint 2 | Paint 3 |
|---|---|---|---|
| Sample 7 | 40.44 | — | — |
| Sample 8 | — | 42.80 | — |
| Sample 9 | — | — | 44.10 |
| Distilled water | 40.10 | 42.70 | 44.30 |
| Ammonia (25% strength) | 1.00 | 0.90 | 1.90 |
| Ethyl diglycol¹ | 16.00 | 9 | 4.40 |
| Tegofoamex 822² | 0.16 | 0.90 | 0.90 |
| Tegofoamex 810² | 0.30 | 0.60 | — |
| Byk 346³ | 0.50 | — | 0.90 |
| Cognis 3290 thickener (50% strength | 1.50 | 3.10 | 3.50 |
| in butyl glycol/water 1:1)⁴ | | | |
| | 100.00 | 100.00 | 100.00 |
| pH (TM 39) | 8.70 | 8.60 | 8.30 |
| Particle size [nm] laser diffraction | 69.21 | 107.1 | 125 |
| method (dispersion only) | | | |
| Glass transition temperature DSC | 108° C. | 88° C. | 25° C. |
| measurement | | | |

1 Coalescence agent for the filming of the dispersions, 2 Defoamers in the form of a polyethersiloxane copolymer, silica-containing, 3 Substrate wetters in the form of a solution of a polyether-modified siloxane, 4 Polyurethane thickener.

As expected, on the basis of the high glass transition temperature, the comparative dispersion required the highest fraction of coalescence agent. The aqueous formulations were applied with a four-way bar applicator (200 μm wet application) to black PVC sheet, glass, and wood (beech veneer). Following application, the formulations underwent foam-free filming. Thereafter, the coated substrates were dried at 40° C. (circulating air temperature) in a laboratory oven for 8 hours. The paint films were then subjected to various tests. The results of these tests are set out in table 4 below.

TABLE 4

| Test method | Paint 1 | Paint 2 | Paint 3 |
|---|---|---|---|
| Konig pendulum damping (“hardness”) | 95 s | 87 s | <15 s |
| Based on DIN EN ISO 1522 | | | |
| Gloss (EN ISO 2813) 60° measuring | 38 | 46 | 10 |
| angle | | | |
| Adhesive strength DIN ISO 2409 | 1-2 | 0 | 0 |
| Line 1: PVC sheet, line 2: glass | 5 | 3-4 | 3-4 |
| Line 3: beech veneered wood | 1 | 0 | 0 |
| 0 = very good adhesive strength | | | |
| 5 = very poor adhesive strength | | | |
| Water test 1 h exposure | 1-2 | 2-3 | 4 |
| Based on DIN 68861 Part 1 B/C | | | |
| 5 = very good resistance | | | |
| 1 = very poor resistance | | | |
| Alcohol. test 10 minutes exposure | 3 | 3-4 | 4-5 |
| (48% strength solution in water) | | | |
| based on DIN 68861 Part 1 B/C | | | |
| 5 = very good resistance | | | |
| 1 = very poor resistance | | | |
| Assessment of grain highlighting* | 1 | 3 | 5 |
| 5 = very good | | | |
| 1 = very poor | | | |

*The term “grain highlighting” refers to the intensification of color which occurs when the wood surface is wetted by the coating material and which lastingly emphasizes the wood grain (Prieto/Kiene: “Holzbeschichtung” textbook, Coatings Compendien, Curt Vincentz-Verlag Hannover, 2007)

As can be seen from table 4, the aqueous dispersions paint 2 and paint 3, in comparison to the comparative sample paint 1, lead to an improvement in the adhesive strength to glass and PVC sheet. In the “chemicals test”, based on DIN 68861 Part 1 B/C, the surfaces coated with paint 2 and paint 3 likewise tend to score better than the comparative sample paint 1. The best chemical resistances (water, alcohol) are exhibited by the dispersion paint 3. At the same time, this dispersion also shows the lowest pendulum damping values (softer than paint 1 and paint 2; the aqueous dispersions paint 1 and paint 2 exhibit very similar pendulum damping values). The highest gloss, based on DIN EN ISO 1522, is shown by the formulations as per paint 1 (38) and paint 2 (46). In a comparison of the “highlighting” on beech (veneered), surprisingly, the dispersion paint 3 exhibits particularly good “highlighting”, exceeding the current level of the known aqueous polyacrylate dispersions.

As an outcome of the experiments, it has been possible to show that the modification of aqueous polyacrylate dispersions with polyurethane polymers (nanoscale) leads to paint films having improved profiles of properties. The tendency is that it is possible to improve the adhesive strength, the chemical resistance (water, alcohol), and also the “highlighting” of wood substrates.

1-16. (canceled)

17. A polymer prepared by a process comprising:
a) reaction of at least one polyisocyanate with at least one polyol and optionally at least one radically curable monomer A having isocyanate-reactive groups in at least one radically curable monomer B to form polyurethane particles having an average diameter of less than 40 nm, preferably less than 20 nm, and more preferably less than 10 nm, and an average number of radically curable functionalities in the range from 2 to 4, preferably 2 to 3; and
b) emulsion polymerization of the polyurethane particles obtained under step a) to form a dispersion.

18. The polymer according to claim 17, wherein the at least one radically curable monomer A having isocyanate-reactive groups comprises a vinyl monomer having isocyanate-reactive groups, preferably a (meth)acrylate having isocyanate-reactive groups.

20. The polymer according to claim 17, wherein a fraction of the polyurethane particles after step a) is 20 to 70 wt %, based on organic components of the polyurethane particles.

21. The polymer according to claim 17, wherein the at least one radically curable monomer B is a vinyl monomer which is unreactive toward isocyanates, preferably a (meth)acrylate, a mixture of (meth)acrylates, or vinylidene chloride.

22. The polymer according to claim 17, wherein a molar ratio of the isocyanate groups to the hydroxyl groups from the at least one polyol in step a) is 1.03 to 1.7.

23. The polymer according to claim 17, wherein the at least one polyol is a high molecular weight polyol having a weight-average molecular weight (Mw) of >500 to 20,000 g/mol.

24. The polymer according to claim 23, wherein the high molecular weight polyol is selected from polyether polyols, especially polytetrahydrofurans, and polyester polyols.

25. The polymer according to claim 23, wherein additionally to the high molecular weight polyol, a low molecular weight polyol having a molar mass of 50 to 500 g/mol is used, preferably 1,4-butanediol, 1,3-propanediol, or a mixture thereof.

26. The polymer according to claim 25, wherein a molar ratio of hydroxyl groups of the low molecular weight polyol to hydroxyl groups of the high molecular weight polyol is 0.3 to 1.2.

27. A process for preparing the polymer according to claim 17, comprising a) the reaction of at least one polyisocyanate with at least one polyol and at least one radically curable monomer A having isocyanate-reactive groups in at least one radically curable monomer B to form polyurethane particles having an average diameter of less than 40 nm, preferably less than 20 nm, and more preferably less than 10 nm, and an average number of radically curable functionalities in the range from 2 to 4, preferably 2 to 3, and b) emulsion polymerization of the polyurethane particles obtained under a).

28. The process according to claim 27, wherein the reaction a) is carried out in a stirred tank at a peripheral stirrer speed of at least 5 m/s, preferably at least 12 m/s, a ratio of a diameter of a stirrer to a diameter of a vessel is 0.3 to 0.80, and a distance of the stirrer from a base of the vessel is 0.25 to 0.5 times the diameter of the stirrer.

29. The process according to claim 27, wherein the emulsion polymerization step takes place with aid of a water-soluble radical initiator, especially with hydrogen peroxide, sodium persulfate, potassium persulfate, ammonium persulfate, corresponding peroxodisulfates, or tert-butyl hydroperoxide.

30. A use of the polymer according to claim 17 as an adhesive, preferably a dispersion-based adhesive, as a constituent of an adhesive or dispersion-based adhesive, or as a constituent of an adhesive tape.

31. A use of the polymer according to claim 17 for coating of a substrate, preferably as paint or constituent of a paint, or for coating of textiles.

32. A use of the polymer according to claim 17 as a film or a casting sheet.

33. A use of the polymer according to claim 17, comprising application of the dispersion to a substrate, followed by physical drying, especially by convection drying, and optionally by crosslinking.
